(19) United States
(12) Patent Application Publication
(10) Pub. No.: US 2003/0003282 A1
(43) Pub. Date: Jan. 2, 2003

(54) Thick sheet lamination product and process

(76) Inventors: John E. Roys, Lowell, IN (US); Howard H. Enlow, Munster, IN (US); Paul J. Martus, North Branch, MI (US)

Correspondence Address: CHRISTIE, PARKER & HALE, LLP, 350 WEST COLORADO BOULEVARD, SUITE 500, PASADENA, CA, 91105, US

(21) Appl. No.: 10/138,171

(22) Filed: May 3, 2002

Related U.S. Application Data
(63) Continuation-in-part of application No. 09/945,000, filed on Aug. 31, 2001.
Application No. 09/945,000 is a division of application No. 09/093,471, filed on Jun. 8, 1998, now Pat. No. 6,284,183.

(51) Int. Cl. B32B 7/02

(52) U.S. Cl. 428/213; 428/327; 428/323; 156/331.4; 156/333

(57) ABSTRACT

A process for making a low-gloss exterior body panel or member includes forming a thermoplastically formable dry paint transfer film on a heat-resistant temporary carrier having a low-gloss microroughness. The dry paint transfer film has a polymeric outer clear coat layer and a polymeric base coat layer containing a dispersed pigment. The clear coat layer contains (a) uniformly dispersed filler particles in an amount below about five parts by weight of the total resin binder solids and (b) a dispersion of a fluorinated polymeric material in a solvent solution of an acrylic resin. The dispersion has an average particle size from about 20 to about 35 microns. The dry paint transfer film is laminated to a semi-rigid thermoplastically formable resinous backing sheet on a side opposite from the clear coat layer. A relatively thick substrate sheet is extruded from a thermoformable polymeric material. A paint-coated thick sheet laminate is formed by laminating the backing sheet to the extruded sheet. The clear coat layer is dried in contact with the carrier to transfer its surface microroughness to the outer surface of the clear coat. The thick sheet laminate is vacuum formed to a three-dimensional shape to produce a finished body panel or member in which the transfer film has a uniform 60-degree gloss of less than about 15 gloss units.

### CROSS-REFERENCE TO RELATED APPLICATIONS

This is a continuation-in-part of Application No. 09/945,000, filed Aug. 31, 2001, entitled THICK SHEET LAMINATION PRODUCT FOR USE IN EXTERIOR AUTOMOTIVE BODY PANELS, which is a division of application Ser. No. 09/093,471, filed Jun. 8, 1998, now U.S. Pat. No. 6,284,183, which is incorporated herein by reference.

### FIELD OF THE INVENTION

This invention relates to the manufacture of exterior body panels or members made from polymeric materials, and more particularly, to a thick sheet dry paint transfer-lamination process for applying preformed paint film laminates to extruded plastic substrate sheet materials. The process can avoid the separate processing step of injection molding a substrate panel to the dry paint transfer laminate. One embodiment of the invention relates to the manufacture of high-gloss exterior automotive body panels, and another embodiment relates to the manufacture of low-gloss exterior weatherable body panels or members.

### BACKGROUND OF THE INVENTION

The present invention is described below with respect to exterior automotive body panels, although other aspects of the invention relate to the manufacture of exterior weatherable body panels and members generally, including exterior weatherable body panels or members having a low-gloss surface.

Exterior automotive body panels have been made in the past by spray painting sheet metal parts. Multi-layer paint coats, such as those referred to as clear coat/color coat paint systems, have been used to produce desirable optical effects. In addition to high-gloss and high distinctness-of-image (DOI), these paint coats also are highly durable by providing chemical resistance, abrasion resistance and weatherability that avoids degradation by ultraviolet light.

In more recent years, molded plastic car body panels have been made with decorative clear coat/color coat paint films bonded to the molded plastic panel. Use of such films avoids certain environmental problems associated with evaporation of paint solvents while also reducing or eliminating the need for paint facilities and emission controls at the automotive production plant.

Because of the growing need to reduce atmospheric pollution caused by solvents emitted during the painting process, different approaches have been taken in recent years for producing these decorative films. For instance, U.S. Pat. No. 5,707,697 to Spain et al. describes solution-casting techniques in which liquid-cast solvent-based clear coats and pigmented base coats are applied to a flexible casting sheet by a coating process such as reverse roll coating. The liquid-cast layers are separately applied and then dried at high temperatures to evaporate the solvents. The composite paint coat is then removed from the carrier and transfer-laminated to a thin, semi-rigid, thermoformable polymeric backing sheet. The preferred backing sheet is about 20 mils in thickness, although the backing sheet can have a thickness from about 10 mils to about 40 mils. The paint coated backing sheet is then thermoformed into a desired three-dimensional shape, followed by molding the substrate panel to the thermoformed sheet in an injection mold. This process, known as the “insert-mold” process, together with the transfer-lamination and thermoforming steps, are described in the above-mentioned '697 patent which is incorporated herein by this reference.

As an alternative to solvent-cast films, extruded films have been used for making exterior automotive clear coat/color coat paint films. International Application WO 96/40480 to Enlow et al., which is incorporated herein by this reference, describes an approach in which paint films and/or laminates are made by extrusion coating or coextrusion techniques. The paint film is transferred to a supportive backing sheet by transfer-lamination techniques, followed by thermoforming the paint coated backing sheet into a desired three-dimensional shape and injection cladding it to a substrate panel by the insert-mold process.

As a further alternative, a dry paint transfer sheet can be placed directly in an injection mold without first thermoforming it outside the mold. The sheet in this instance is formed into a contoured shape under heat and pressure in the injection mold by the molding material in what is referred to as the “in-mold” process. Such a process, for example, is described in U.S. Pat. No. 4,810,540 to Ellison et al.

One aspect of the present invention is based on a recognition that production costs for making exterior body panels and members can be reduced by eliminating the injection-molding step. In other words, it can be desirable to manufacture an exterior body member or panel having a weatherable decorative finish, so that the finished part, such as a facia or a structural body panel or member, is ready for use after the thermoforming step. This would require producing a polymeric substrate sheet with sufficient thickness and structural integrity to function as a finished part that adequately supports the transferred paint film. This also requires a polymeric substrate material that can be shaped by thermoforming techniques while not interfering with the desired optical properties of the finished paint film (such as high distinctness-of-image and gloss or a controlled uniform low-gloss finish).

For instance, it may be desirable to use polymeric substrate materials that contain high filler or regrind components in order to reduce the cost of the overall product. But the presence of these particulate materials can be transmitted from the substrate to the paint film surface during thermoforming, creating imperfections that degrade the otherwise desired smooth, high quality optical surface of the finished film. In addition, the thicker substrate sheet material can absorb substantial amounts of heat when bonding a paint film to it or when thermoforming it. Such excessive heat absorption can be transferred to the paint film surface and degrade the optical properties of the paint film by causing excessive haze or fogging of the clear coat. This problem is particularly critical when such exterior paint films are made from fluoropolymer resins, such as polyvinylidene fluoride (PVDF) and acrylic resin alloys of the types described in the above-mentioned '697 patent to Spain et al., International Application WO 96-40480 to Enlow et al., or the '540 patent to Ellison et al.

As an alternative to high-gloss, high DOI exterior automotive paint finishes, there is a need to develop exterior weatherable body panels or members having a uniform low-gloss surface. Such low-gloss levels can be difficult to achieve in a decorative paint film subjected to thermoforming and elongation during the process of forming a thick sheet laminate into a finished three-dimensional shape. Problems confronted include (a) uneven thinning of the paint coat and undesired color changes during thermoforming, (b) gloss control to produce a natural-looking uniform low-gloss surface on a three-dimensionally shaped part where the decorative film has elongated during thermoforming, and (c) avoiding undesired shrinkage of the decorative film caused by cooling of the film after the film is subjected to the heat of extrusion from an extruded sheet to which the film is bonded.

### SUMMARY OF THE INVENTION

Briefly, one embodiment of this invention provides a process for making exterior body members or panels from a preformed dry paint transfer laminate comprising an exterior weatherable decorative paint film applied to a relatively thin, semi-rigid, thermoformable polymeric backing sheet. The process includes the step of extruding a relatively thick sheet of a thermoformable polymeric material and forming a paint coated thick sheet laminate by laminating the backing sheet side of the preformed dry paint laminate to the extruded sheet. The lamination step can be carried out using the heat of extrusion to heat bond the backing sheet to the extruded sheet to form an integral substrate sheet which is thermoformable to a three-dimensional shape. The backing sheet and extruded sheet can comprise compatible polymeric materials to promote the bond between them. In one embodiment, the extruded sheet has a thickness of at least twice the thickness of the backing sheet. In another embodiment the backing sheet has a thickness from about 10 mils to about 30 mils, and the extruded substrate sheet has a thickness of at least about 40 mils. Extruded sheet thickness can range from about 60 mils to about 300 mils in some embodiments. The lamination step is followed by forming the laminate to a three-dimensional shape, preferably by vacuum forming, to produce a finished contoured exterior body panel or member.

One embodiment of the present invention provides a process for manufacturing a high quality exterior automotive paint finish (high-gloss and high DOI) on a body member of panel of a thickness up to about 0.30 inch (300 mils), by first laminating the dry paint transfer film to the relatively thin polymeric backing sheet, and subsequently laminating the backing sheet to the substantially thicker extruded substrate sheet. The intermediate backing sheet provides a barrier that prevents transmission of defects (from filler and regrind materials contained in the substrate sheet material) to the paint film surface, thereby preserving the high-quality optical properties of the finished film when thermoformed to a finished three-dimensional shape.

In another embodiment, in which a low-gloss weatherable exterior decorative paint film is transferred to the thick sheet laminate, the intermediate backing sheet provides a barrier that prevents transmission of defects from the extruded substrate sheet material to the low-gloss surface.

One advantage of the process is elimination of a subsequent injection molding step. This greatly reduces production costs because the high cost of an injection molding tool is avoided. Processing time also is reduced.

In one form of the invention, the extruded substrate sheet is rapidly cooled following extrusion and prior to lamination to the dry paint transfer laminate. This avoids high levels of heat being transmitted to the paint film which could otherwise be at a level sufficient to cause haze or other degradation of the optical properties of the paint film. Haze is undesirable not only in the clear coat for high gloss applications (because it lowers gloss and DOI), but haze is undesirable also in the color coat, because it can produce undesired color changes causing difficulties in color matching. Further, preferred thermoforming techniques include preheating the extruded substrate sheet under controlled heating conditions prior to thermoforming. This can reduce the amount of heat to which the paint film is exposed during thermoforming to further control excessive heat transmission to the paint film.

Another embodiment of the invention comprises a process for making low-gloss exterior weatherable body panels or members. The process includes forming a thermoplastically formable dry paint transfer film on a heat-resistant temporary carrier, in which the carrier surface has a low-gloss microroughness. The dry paint transfer film comprises a polymeric material in contact with the carrier surface, and at least one underlying base coat layer comprising a polymeric material containing a dispersed pigment. The clear coat layer contains (a) uniformly dispersed filler particles in an amount below about five parts by weight of the total resin binder solids contained in the outer clear coat and (b) a dispersion of an optically transparent fluorinated polymeric material in a solvent solution of an acrylic resin. The dispersed fluorinated polymeric material has an average particle size from about 20 to about 35 microns and is uniformly dispersed in the solution of acrylic resin. A pre-formed dry paint laminate is formed by laminating the dry paint transfer film to a thermoplastically formable resinous semi-rigid backing sheet or flexible film adhered to a side of the dry paint transfer film opposite from the clear coat layer. A relatively thick substrate sheet is extruded from a thermoformable polymeric material. A paint-coated thick sheet laminate is formed by laminating the backing sheet or film side of the pre-formed dry paint laminate to the extruded sheet. The extruded substrate sheet has a thickness at least twice the thickness of the backing sheet or its supportive film. The polymeric material of the extruded substrate sheet has a substantially higher filler content than the backing sheet or film material. The clear coat layer is dried in contact with the carrier and then transferred from the carrier to transfer its surface microroughness to the outer surface of the clear coat. The thick sheet laminate is formable to a three-dimensional shape to produce a finished exterior low-gloss body panel or member in which the dry paint transfer film comprises an exterior base coat/clear coat paint film having a uniformly distributed low-gloss surface of less than about 15 gloss units measured at 60 degrees.

This process produces three-dimensionally shaped body panels or members having a natural-looking uniform low-gloss surface in which the process avoids the problems of induced color change, uneven thinning of the decorative film, and undesired shrinkage of the decorative film caused by the heat of extrusion.

These and other aspects of the invention will be more fully understood by referring to the following detailed description and the accompanying drawings.

### BRIEF DESCRIPTION OF THE DRAWINGS

FIG. 1 is a schematic cross-sectional view illustrating one embodiment of a preformed laminate comprising an exterior automotive quality dry paint transfer film adhered to a thin, semi-rigid polymeric backing sheet.

FIG. 2 is a schematic side elevational view showing a coextrusion process for making the backing sheet and adhesive layer component of the laminate shown in FIG. 1.

FIG. 3 is a schematic side elevational view showing a process for transfer-laminating a dry paint transfer film to a backing sheet.

FIG. 4 is a schematic side elevational view showing a process for extrusion lamination to make thick sheets.

FIG. 5 is an alternative embodiment of the extrusion lamination process of FIG. 4.

FIG. 6 is a schematic view illustrating thermoforming of the thick sheet laminate produced by the steps shown in FIG. 4.

FIG. 7 is a schematic cross-sectional view showing the finished part following thermoforming to a three-dimensional contour.

FIG. 8 is a schematic side elevational view showing a process for twin sheet forming a reinforced finished part.

FIG. 9 is a schematic side elevational view showing a process for cap sheet laminating a low-gloss decorative film laminate to an extruded substrate sheet.

FIG. 10 is a schematic side elevational view showing a process for cap sheet laminating a low-gloss decorative film laminate on the extruder line downstream from the extruder die.

FIG. 11 is a schematic side elevational view showing a process for transfer laminating a low-gloss decorative film to an extruded sheet using a separate laminating station located downstream from a three roll vertical calendering roll stack.

FIG. 12 is a schematic side elevational view showing a process for transfer laminating a low gloss decorative film laminate to an extruded substrate sheet downstream from a horizontal calendering roll stack.

FIG. 13 is a schematic side elevational view showing a process for transfer laminating a pair of low gloss decorative films side-by-side to an extruding sheet using separate laminating stations located downstream from a three roll vertical calendaring roll stack.

FIG. 14 is a schematic side elevational view similar to FIG. 13 but showing a process for transfer laminating a low gloss decorative film laminate to an extruded substrate sheet downstream from a three roll vertical calendaring roll stack followed by laminating a formable masking film to the resulting laminated structure.

FIG. 15 is a schematic side elevational view showing a process for laminating a flat extruded sheet to a decorative film.

### DETAILED DESCRIPTION

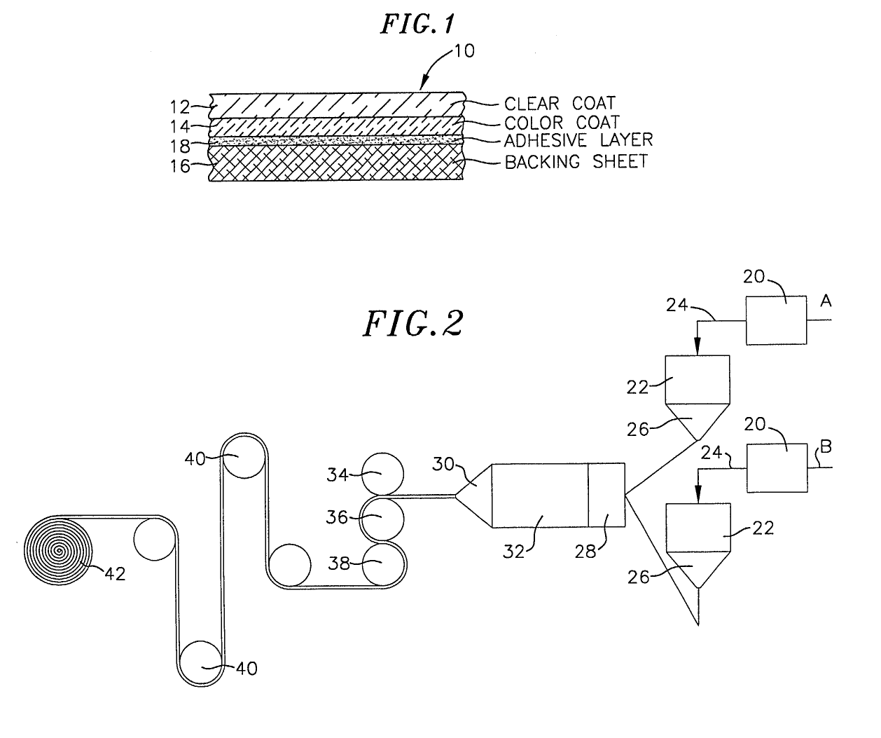

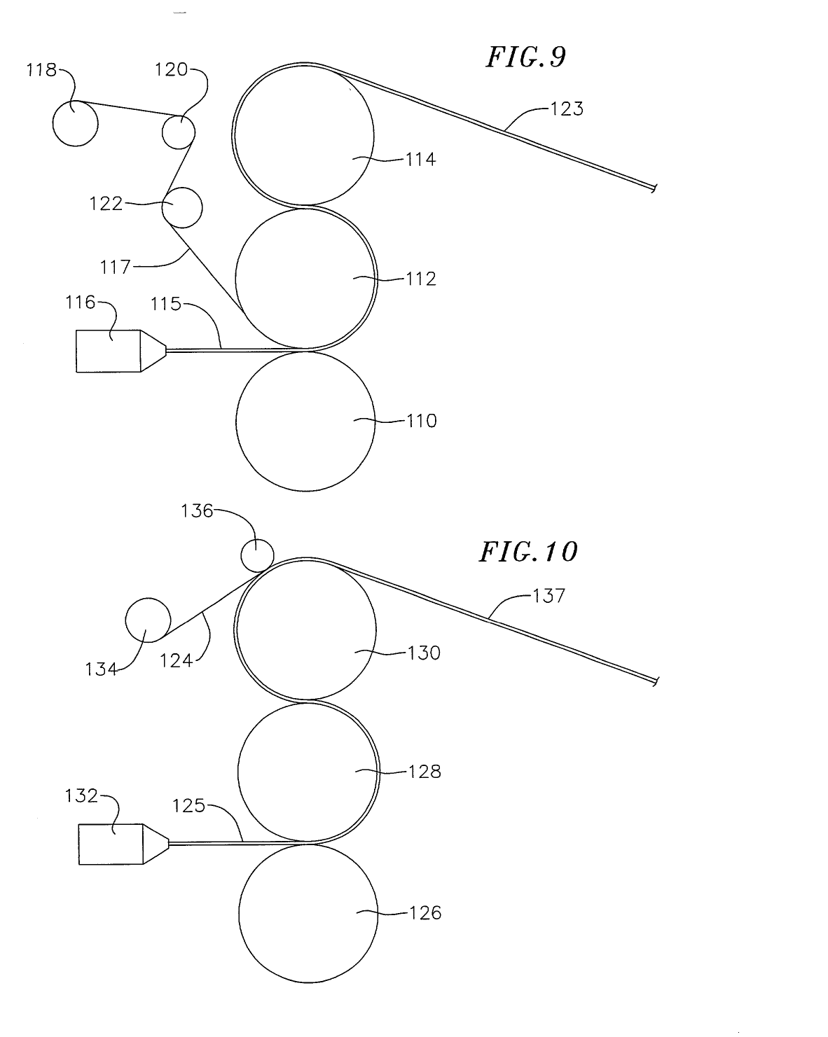

High gloss exterior automotive applications of the invention will first be described with reference to FIGS. 1 to 8. Low-gloss application of the invention are described with reference to FIGS. 9 to 12.

An exterior automotive quality paint film is applied to a polymeric substrate sheet by a combination of steps which include forming a dry paint transfer film of exterior automotive quality, transferring the dry paint film to a thin supporting backing sheet, laminating the resulting preformed dry paint film laminate to an extruded thick substrate sheet, and thermoforming the resulting paint coated laminate to the shape of a finished part. FIG. 1 illustrates one embodiment of the invention in which the initial dry paint transfer laminate 10 comprises an exterior automotive base coat/clear coat paint film which includes an outer clear coat 12 and an underlying pigmented color coat 14. The clear coat/color coat paint film can comprise any exterior automotive dry paint transfer film which is weatherable, durable, thermoformable, and has thermoplastic properties in the sense that the paint film can be subjected to elongation under application of heat in a thermoforming process to shape the film to a finished three-dimensional contour while retaining exterior automotive durability and optical properties required for exterior automotive use. In one preferred form of the invention, the clear coat layer is preferably a dry paint film having a thickness of about 0.5 to about 1.5 mils. For metallic paint films, the clear coat can have a thickness up to about 2 mils. The clear coat preferably comprises a blend of a thermoplastic fluorinated polymer and an acrylic resin. The preferred clear coat preferably contains a thermoplastic fluorocarbon such as polyvinylidene fluoride (PVDF). The fluorinated polymer can comprise a homopolymer or copolymers and terpolymers of vinylidene fluoride. The acrylic resin component of the clear coat can be a polymethyl methacrylate or a polyethyl methacrylate resin or mixtures thereof. A preferred formulation comprises from about 50% to about 70% PVDF and from about 30% to about 50% acrylic resin, based on the total resin solids in the paint film. Formulations suitable for preparing clear coat paint films useful in practicing this invention are described in more detail in U.S. Pat. No. 5,707,697 to Spain et al. which is incorporated herein by reference.

The Spain, et al. '697 patent discloses solvent-casting techniques that can be used for making the base coat/clear coat paint film. According to that process, the clear coat and color coat are cast in sequence on a polyester carrier sheet and dried to evaporate the solvents. The clear coat is cast on a high-gloss, smooth polyester casting film in order to transfer high quality optical properties to the clear coat surface.

The color coat 14 is cast on the clear coat after the clear coat has been dried on the carrier sheet. The color coat can be coated on the dried clear coat, or the color coat can be coated on a separate polyester casting film, dried, and later transferred from the casting film to the clear coat. In either case, the color coat is preferably applied to the casting film by reverse roll coating, comma coating, or die coating techniques similar to those used in forming the solvent-cast clear film. The color coat preferably comprises a thermoplastic synthetic resinous coating composition containing a level of pigment and/or metallic flakes to provide the necessary appearance for exterior automotive use of the finished part. The color coat contains a sufficient amount of pigment to maintain sufficient opacity and distinctness-of-image while avoiding stress whitening throughout the thermoforming step so as to function as an exterior automotive paint coat. The pigmented base coat may contain a sufficient amount of reflective flakes to provide metallic base coat/clear coat paint films and their resulting desirable optical properties, if desired. The preferred dry film thickness of the color coat is about 0.5 to about 1.5 mils. In a preferred form of the invention, the color coat comprises a blended thermoplastic fluorinated polymer and acrylic resin paint system similar to the paint system used in forming the clear coat. As with the clear coat, suitable color coat formulations also are described in the previously referenced Spain et al. '697 patent.

As an alternative to the base coat/clear coat paint film of FIG. 1, the exterior automotive paint film may include a combination exterior clear coat and a tint coat, or the paint coat may comprise a single dry thin film coating of a pigmented synthetic resinous material having desired exterior automotive properties. Alternatively, the base coat/clear coat paint film may be produced by extrusion coating techniques such as those described in International Application WO 96/40480 to Enlow et al. which is incorporated herein by reference.

Whether the paint film is made from solvent casting techniques or extrusion coating techniques, in either instance the dry paint transfer film is laminated to a thermoformable backing sheet 16 with an intervening adhesive layer or size coat 18. The backing sheet is a semi-rigid, self-supporting, thin, flat sheet of a thermoformable polymeric material. The backing sheet is made from a material having a thickness capable of thermoforming into a complex three-dimensional shape while protecting the outer paint film from transmission of defects from an underlying substrate sheet 56 described below. The material from which the substrate sheet is made can contain a substantial amount of filler or regrind particles and therefore can produce imperfections in the surface of the finished article. The backing sheet has a thickness in the range from about 10 mils to about 30 mils. The preferred material from which the backing sheet is made is ABS, thermoplastic olefins (TPO), or other olefinic materials containing polypropylene or polyethylene. The thickness of the backing sheet is sufficient to absorb defects from the underlying substrate sheet to avoid transmission of defects to the surface of the paint film. The backing sheet material also is of substantially higher grade than the underlying substrate material. The higher quality backing sheet material has a substantially lower gel count than the substrate material. The substrate material also can contain filler and a regrind content up to about 30% of its total volume and/or weight. Such filler and regrind materials are essentially absent from the backing sheet material.

FIG. 2 illustrates one process for making a composite backing sheet and adhesive layer by coextrusion techniques. Alternatively, a single-layer preformed backing sheet can be adhered to an adhesive size coat which has been coated on the color coat side of the dry paint film. The size coat is bonded to the backing sheet in a transfer-lamination process such as that described in the above-referenced U.S. Pat. No. 5,707,697 to Spain et al. The size coat comprises any synthetic resinous material which is heat activated during the transfer-lamination step to bond the paint coat to the backing sheet. A preferred dry film thickness of the size coat is from about 0.1 to about 1.0 mil. The size coat is preferably applied as a thermoplastic paint coat and dried in the same multi-stage drying step used in drying the clear coat and color coat. For a PVDF-acrylic based paint system, an acrylic resin based size coat is preferred for suitable bonding of the paint coat to the backing sheet. In one embodiment, in which the paint coat is adhered to a backing sheet made of acrylonitrile-butydiene-styrene (ABS) the size coat can comprise a polymethyl-methacrylate resin dissolved in a suitable solvent and dried. In another embodiment, in which the backing sheet is a thermoplastic polyolefin, or is made from an olefinic material such as polypropylene, the size coat can comprise a composite of an acrylic resin layer for bonding to the color coat and a suitable chlorinated polyolefin bonding layer for bonding to the olefin-based backing sheet.

FIG. 2 illustrates a coextrusion process for making the backing sheet 16 and its adhesive layer 18. In one embodiment the coextrusion is made from starting materials comprising an acrylic resin A and an ABS resin B. Both resin materials are fed to separate driers 20 for removing excess moisture before extruding. Dried resin pellets of each material are fed from the drier into hoppers 22 via vacuum tubes 24. From the hoppers the pellets are gravity fed to separate extruders 26. The pellets are fed into the feed section of each extruder barrel. The resins in each extruder are heated to a molten state and fed through their respective barrel sections to a single combining block 28 and then into the die 30 of an extruder 32. The molten coextruded sheet exits the die and runs through a three-roll calendering (polishing) stack comprising an upper roller 34, an intermediate roller 36, and a bottom roller 38. The calendering operation polishes both sides of the coextruded sheet. The sheet then passes downstream away from the extruder and is cooled by passing over chill rolls 40 and is finally wound on an exit roll 42. In one embodiment, the final coextruded sheet comprises from about 0.8 to about 1.5 mils acrylic lacquer adhesive layer and a 28.5 mil ABS backing sheet layer. Other embodiments also are useful in practicing the invention as described in examples below.

FIG. 3 shows a transfer-lamination process for applying the dry paint transfer film to the backing sheet. In the process illustrated in FIG. 3 the backing sheet can either comprise a separate backing sheet with an adhesive size coat as described in U.S. Pat. No. 5,707,697 to Spain et al., or it can comprise the coextruded sheet described with reference to FIG. 2. Referring to FIG. 3 the laminating step includes the paint coated carrier stored on a top unwind roll 44 and a flexible adhesive coated backing sheet stored on a bottom unwind roll 46. The carrier and backing sheet pass between a heated laminating drum 47 and a rubber backup roll 48. The laminating drum is preferably made of steel and operated at a temperature of about 400° to 425° F. It is pressed into contact with the overlapping sheets to heat them to a temperature sufficient to activate the adhesive layer and press the two sheets into contact with each other to bond the paint coat to the backing sheet. The rubber backup roll 48 is pressed into contact with the laminating roll preferably at a pressure of about 300 pounds per lineal inch. The polyester carrier sheet on which the paint film is cast is stripped away from the paint film and passed to a take-up roll 49. A thin protective film such as polyvinyl acetate is unwound from a storage roll 50 and laminated to the clear coat side of the paint film by laminating rolls 51. The sheets travel around the drums 60, 62 and 64 at a slow speed during laminating to ensure that the resulting laminate 52 is heated to a temperature approaching the temperature of the laminating drum. This softens the backing sheet material somewhat as well as activating the adhesive layer to ensure a complete bond between the paint coat and the backing sheet. The polyester carrier sheet of the paint coated film has a heat resistance well above laminating temperature so the carrier resists elongation during the laminating step. Following the transfer-lamination or bonding step, the flexible paint coated laminate 52 is then passed around one or more chill rolls (not shown) for cooling the laminate to room temperature. Prior to passing around the chill rolls the film is laminated with the protective outer film 50 while the top coat is warm. The finished laminate 52 then passes onto a laminate rewind drum 54.

The coextrusion process of FIG. 2 simplifies the production process when compared with a process for producing a preformed backing sheet and laminating it to a paint film to which the size coat has been solvent cast. By coextruding the backing sheet and adhesive layer, the step of separately coating the size coat to the dry paint film by a reverse roll coater is eliminated.

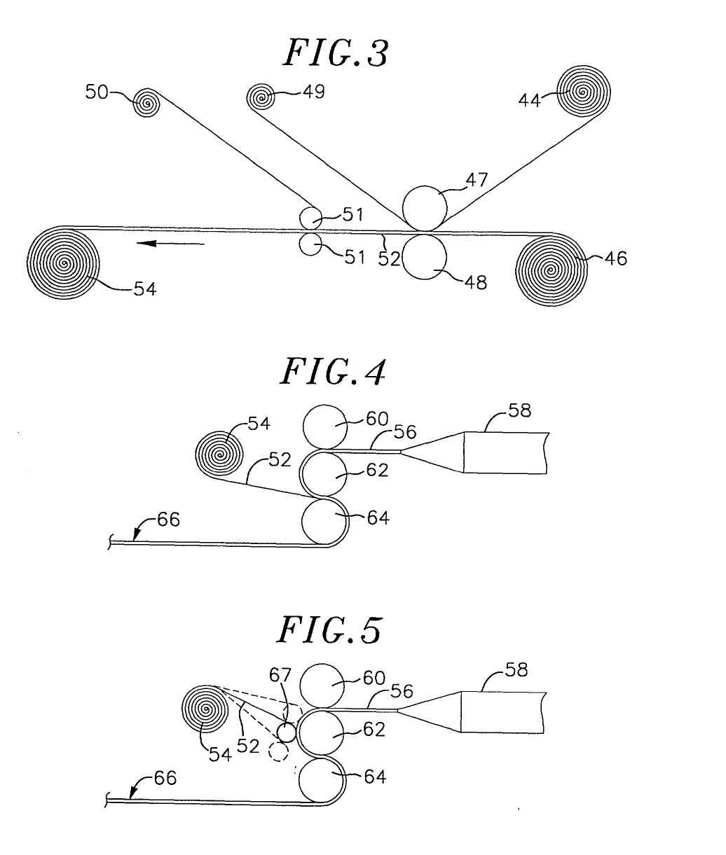

Referring to FIG. 4, the preformed paint film laminate 52 is next laminated to the top of a thick polymeric substrate sheet preferably when the substrate sheet is extruded. A thick substrate sheet 56 is initially extruded from the die of an extruder 58. The extruded sheet then passes through a three-roll calendaring stack comprising an upper roll 60, an intermediate roll 62 and a bottom roll 64. The extruded sheet first passes between the upper and intermediate rolls which are operated at temperatures for immediately cooling the sheet to stabilize it. The sheet is also polished on both sides by the rolls. The extruded sheet then wraps around the intermediate roll 62 and passes between the nip of the rolls 62 and 64. At the same time, the paint film laminate 52 is unwound from roll 54 and passes into the nip of the same rolls 62 and 64. This applies heat and pressure to fuse the backing sheet side of the laminate 52 to one side of the extruded thick sheet 56. This extrusion lamination step produces a composite thick sheet laminate 66 with the paint film laminate bonded as an integral unit to the extruded thick sheet substrate. Preferably, the bottom roll 64 of the stack is operated at a lower temperature than the other two rolls for providing further temperature reductions in the lamination step. The preferred approach is to pass the paint film laminate 52 through the nip on the side contacted by the bottom roll 64 of the stack so that its lower roll temperature is applied directly to the carrier sheet side of the paint film laminate when joining the laminate to the extruded sheet 56.

FIG. 5 illustrates an alternative extrusion-lamination process similar to FIG. 4, but with a modification that accommodates lamination of paint film-backing sheet laminates to thinner extruded substrate sheets. In FIG. 5 the paint film-backing sheet laminate 52 is bonded to the extruded sheet at a higher point on the intermediate roll 62. The laminate 52 in this instance is applied at the nip of the intermediate roll 62 and a separate laminating roll 67. The purpose is to raise the level of the nip closer to the center of the roll 62 for thinner extruded substrates (say in the 40 mil range) and to gradually lower the nip to the point shown in FIG. 4 for thicker extruded substrate sheets (say in the 200 to 250 mil range). The adjustment of the nip location maintains desirable paint film temperatures so they are not adversely affected as residual heat in the substrate increases.

The thick substrate sheet is extruded at a thickness that coincides with the desired thickness of the finished part. According to the present invention, an objective is to avoid a subsequent injection molding step in forming the substrate component of the finished part. The extruded substrate sheet component provides the necessary rigidity or structural integrity of the finished part, and yet the substrate sheet must be sufficiently thermoformable to be shaped by thermoforming into the desired contour of the finished part. In one form of the invention, the extruded substrate sheet has a minimum thickness of at least about two to about three times the thickness of the backing sheet. In one embodiment, the backing sheet is about 10 to 12 mils thick and the extruded substrate sheet is about 48-50 mils thick. In another embodiment, the backing sheet is about 18 to 20 mils thick and the extruded substrate sheet is about 0.20 to 0.25 inch thick. Insofar as relative dimensions are concerned, the backing sheet preferably has a thickness in the range of about 10 to about 30 mils, and the extruded thick substrate sheet has a thickness in the range from about 40 mils to about 0.30 inch.

The substrate sheet 56 is preferably made from a material comprising essentially the same polymeric composition or at least a polymeric composition compatible with the polymeric material contained in the backing sheet, in the sense that the two materials may be compatibly fused together under heat as an integral structural unit. In one form of the invention, the thick substrate sheet material is extruded as illustrated in FIG. 4, and the substrate material is sufficient to fuse to the backing sheet using the heat of extrusion to heat bond the two sheets together as an integral unit by melt adhesion techniques.

The preferred materials from which the thick substrate sheet is made are ABS, for bonding to an ABS backing sheet, or TPO including polypropylene or polyethylene when bonding the thick sheet to similar compatible materials contained in the backing sheet. The paint film on the surface of the finished laminate 66 has a defect-free surface, maintaining the desired optical properties of an automotive quality paint finish. Any defects in the substrate material, such as filler particles or regrind material, are absorbed by the intervening backing sheet to provide the defect-free paint coat.

During extrusion-lamination the molten material extruded at the die opening of the extruder typically has a temperature of about 400° to 450° F., depending upon the polymeric extruded material. The temperature at which lamination takes place is substantially lower, owing to the temperature reduction produced by the calendaring rolls next to the extruder die exit opening. In one embodiment, the upper roll 60 is operated at a temperature in the range of about 200° to about 216° F., the intermediate roll 62 is operated at a temperature in the range of about 175° to about 210° F., and the bottom roll 64 is operated at a temperature in the range of about 150° to about 205° F. This lowers lamination temperature (sheet temperature) at the nip of the intermediate and lower calendaring rolls to about 380° to about 420° F. At these temperature levels the paint film laminate can be successfully bonded to the extruded thick substrate sheet while the necessary heat levels do not adversely cause haze or fogging of the paint film. These roll temperatures are cited as examples only and can be adjusted for controlling heat bonding and absorbed heat levels at the paint film to ensure optical clarity of the finished film, depending upon the materials used. (Similar processing temperatures for producing low-gloss substrate panels are described below with respect to FIGS. 9 to 12.)

It should be noted that in the process of FIGS. 4 and 5, the protective sheet 50 which was applied in the processing step of FIG. 3 remains intact as a protective cover for the paint film during the extrusion-lamination process and the subsequent forming step. The protective sheet also is left in place after the forming step to protect the outer clear coat surface from abrasion.

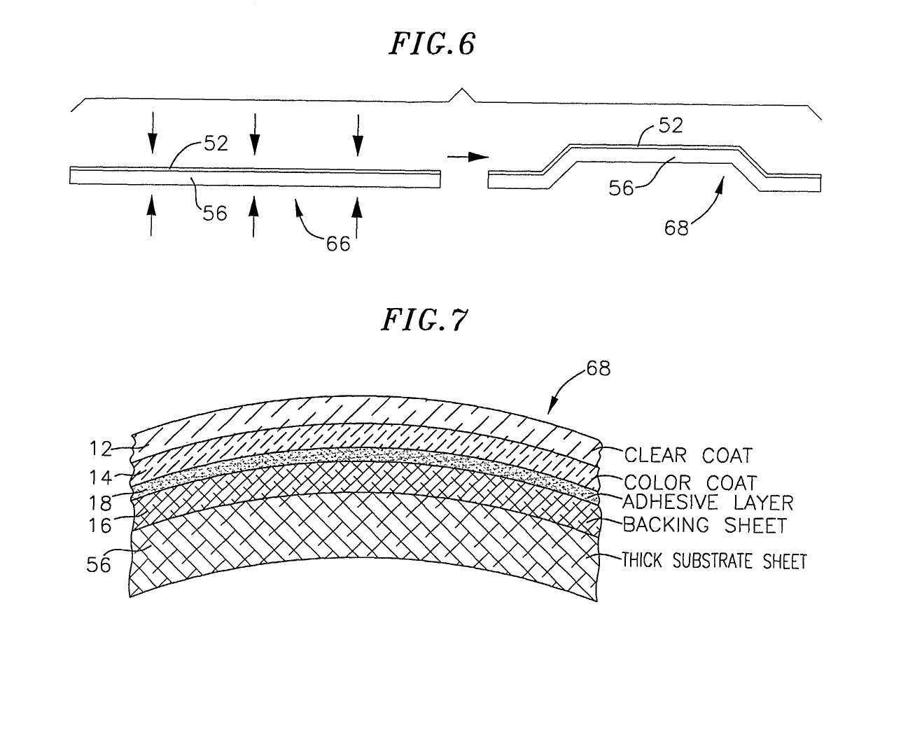

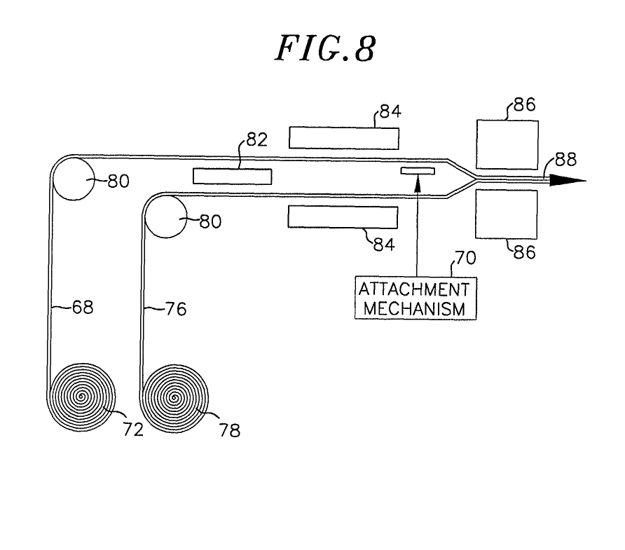

Referring to FIG. 6, the thick sheet laminate 66 is thermoformed into a desired three dimensional shape of the finished part. The initially flat laminate can be formed into a highly contoured three dimensional shape for use as a finished exterior automotive car body panel or member. FIG. 7 schematically shows a three dimensionally shaped thick sheet laminate 68 which has been thermoformed to a finished three dimensional shape following thermoforming. In one embodiment, the thick sheet laminate 66 can be thermoformed and trimmed to produce a finished automotive part, such as a facia or a body side molding trim part, each of which are ready to be put on a vehicle. The process avoids a subsequent molding step for forming a molded substrate or structural component of the finished part. The thermoforming step can be carried out by various types of thermoforming equipment. During thermoforming, the thick sheet laminate is preheated to a thermoforming temperature in an oven, followed by vacuum forming the sheet into a desired three dimensional shape. The thermoforming temperature is in a range which allows softening and thermoplastic elongation of the paint film and its supporting sheet to form the finished part. The actual sheet temperature to which the paint film is subjected (not oven temperature) is at a level that prevents deglossing of the paint film during thermoforming. In one embodiment, sheet temperatures during thermoforming range from about 310° to about 360° F. at the paint film surface of the sheet. The core temperature of the thick substrate sheet also is raised to a temperature substantially within the same temperature range so that heat transmitted to the paint film surface from the substrate does not adversely affect optical properties of the paint film. When the thick sheet laminate is preheated in the thermoformer oven to raise its core temperature to a desired thermoforming temperature, it is desirable to apply proportionately more heat to the back side of the laminate than to the front side of the film. By applying approximately zero to 30% of the heat to the front side and approximately 70% to 100% of the heat to the back side, the back side of the laminate ends up about 20° to 30° F. hotter than the front side. This produces about 20% higher DOI and about 10% higher gloss than a more evenly distributed application of heat. The desired oven temperature of the thermoformer is about 450° to 650° F., and this temperature can vary depending upon the thickness of the substrate sheet and the desired cycle times. For a 60 mil thick sheet, for example, cycle time is about 1.5 to 2 minutes for heating the laminate to its forming temperature. Sheet temperatures in the 340° to 360° F. range produce the best combination of DOI and gloss, in one trial.

FIG. 8 illustrates a post-processing step in which fasteners or reinforcing members can be applied to the finished laminate 68 for use in converting the finished part into a structural panel. The illustrated process is an example of a twin sheet forming process in which an attachment mechanism 70 is embedded in a final laminated sheet 72. The process includes starting with the thick sheet laminate 68 at a storage roll 74 and a separate thick polymeric substrate sheet 76 on a storage roll 78. The two thick sheets pass around separate rolls 80 and are fed to a thermoformer as separated sheets. A preheater 82 located between the sheets preheats both sides of the sheets, along with main heaters 84. The reinforcement mechanism or fastener 70 is inserted into the void space prior to the forming station where forming tools 86 apply heat and pressure to the two sheets to bond them together as an integral structural unit 88 with the attachment device or reinforcement embedded in the final part. The two joined sheets also can be shaped to a contour in the former. This can produce structural parts where the twin substrate sheets (the laminate 68 and the sheet 76) can each have a thickness in the range of 200 to 250 mils, for example, and be bonded together to form the thick structural part 88.

As an alternative, the finished part 68 can have fastener or reinforcement parts attached to it by conventional welding, spin welding or sonic bonding techniques.

### Example 1

Weatherable thermoplastically formable paint films for use in this invention can be made from many suitable polymeric materials and formulations. One such paint system useful in practicing this invention comprises a base coat/clear coat paint system in which each paint film layer comprises an alloy of PVDF and acrylic resins. Such exterior automotive paint films are available from Avery Dennison Corporation under the trademark AVLOY®. A clear coat formulation useful in practicing this invention comprises about 60% PVDF and about 40% acrylic resin, by weight, based on the total resin solids contained in the dry paint film. A typical clear coat formulation, based on parts by weight, is as follows:

| Ingredients | Parts |
|---|---|
| PVDF (KYNAR 500 plus homopolymer- | 20.0 |
| Elf Atochem) | |
| Polyethyl methacrylate (ELVACITE | 12.0 |
| 2042-ICI) | |
| Dispersing agent (Solsperse | 0.06 |
| 17000) | |
| UV absorber (Tinuvin 900) | 0.64 |
| Cyclohexanone | 19.52 |
| Exxate ® 700 - Exxon Chemicals | 21.53 |
| Butylactone (BLO) | 26.25 |

A color coat formulation useful in practicing this invention also comprises about 60% PVDF and about 40% acrylic resin, by weight of the total resin solids contained in the dry film. In this instance a portion of the acrylic resin solids content is provided by the acrylic resin vehicle for the pigment dispersion. A typical color coat formulation for a jet black automotive paint film is as follows:

| Ingredients | Parts |
|---|---|
| PVDF (KYNAR 500 plus - Elf Atochem) | 16.90 |
| Polyethyl methacrylate (ELVACITE 2042) | 10.14 |
| Dispersing agent (Solsperse 17000) | 0.05 |
| UV absorber (Tinuvin 900) | 0.54 |
| Black pigment dispersion | 14.72 |
| Blue pigment dispersion | 0.78 |
| BLO | 22.19 |
| Exxate ® 700 | 18.19 |
| Cyclohexanone | 16.49 |

The pigment dispersions contained in the color coat can vary, depending upon the choice of color. The following pigment dispersions are used in the preceding color coat formulation.

The black dispersion designated as 474-39350 pigment dispersion from Gibraltar Chemical comprises:

| Ingredients | Parts |
|---|---|
| Pigment - (FW 206 DeGussa) | 7.0 |
| Acrylic resin - (B735 - Zenica) | 29.7 |
| Exxate 600 - (Exxon Chemicals) | 31.65 |
| BLO | 31.65 |

The blue dispersion designated as 474-34550 pigment dispersion from Gibraltar comprises:

| Ingredients | Parts |
|---|---|
| Pigment (Palomar Blue - Bayer) | 9.10 |
| Acrylic resin - B735 | 22.30 |
| Exxate 600 | 34.3 |
| BLO | 34.3 |

Various other pigmented color coats can be used without departing from the scope of the invention. In addition to basic pigmented color coats and metallic automotive paints, the color coat also can include print patterns such as Silver Brush sold under the designation AVLOY® by Avery Dennison Corporation. This color coat consists of a base coat comprising a dispersion of metal flake sold under the designation METALURE® by Avery Dennison, together with suitable print coats between the base coat and clear coat, to provide the finished pattern.

The clear coat/color coat paint film may be cap sheet laminated either to a thick ABS substrate sheet or to a thick TPO substrate sheet. In the ABS embodiment, an acrylic adhesive layer approximately 0.8 to 1.5 mils in thickness is coextruded with an ABS backing sheet approximately eleven mils in thickness. The acrylic adhesive is made from acrylic resin materials such as AutoHaas DR 101 or Cyro HS116. The ABS backing sheet is extruded from a premium grade material having a low gel count, such as LSA from General Electric. In one embodiment the extruded thick substrate sheet was extruded at a thickness of about 49 mils and was made from a lower grade general purpose ABS composition having up to 30% regrind materials, such as LS 1000 from G.E. In a similar embodiment an 18 mil thick high grade ABS sheet was cap sheet laminated to a 40 mil thick extruded ABS blended with regrind materials.

In an embodiment comprising a TPO substrate, the adhesive layer is cast as a dual-layer size coat, first with an acrylic size coat for bonding to the color coat side of the paint film, and second, with a chlorinated polyolefin (COPO) size coat cast on the acrylic size coat, for bonding to a TPO backing sheet. The acrylic size coat can comprise ELVACITE 2042 PEMA resin solvent cast from suitable solvents and dried to a film thickness of about 12gm/m². The CPO size coat can comprise DuPont 826 or Hardlyn CP13 resins, solvent cast from suitable solvents and dried to a film thickness of about 12gm/m². In one embodiment, the TPO backing sheet can be a preformed 20 mil thick premium grade TPO such as E 1501 or E 900 from Solvay or R370 from Royalite. The extruded thick TPO substrate sheet can have a thickness from about 0.20 to 0.25 inch and can be made from lower grade materials from the same suppliers.

### Example 2

The objective of this trial was to make a coextruded sheet comprising an acrylic resin adhesive layer and an ABS resin backing sheet. Both the acrylic resin and ABS resin starting materials require drying of excess moisture before extruding. This is accomplished by drying the resin in a desiccant dryer for at least 2 hours at 150° F. for the acrylic resin and 170° F. for the ABS. During extrusion additional resin is added to the dryers as resin is pumped to the extruder via vacuum lines. While running, the dryers are set at 200° F. to dry the resin constantly input to the dryer. The resin should have a final moisture content below 0.08% moisture content to prevent problems with extrusion. The desired moisture content level for extrusion is between about 0.02% to 0.04%. The dried resin pellets of each material are fed into the hoppers on the top of each extruder via vacuum tubes. From the hoppers the pellets are gravity fed into the feed section of the extruder barrel. They are screen fed through the barrel and heated to a molten state. The resins in the two extruders are fed through their respective barrel sections to a single combining block and then into the die of the extruder. The molten sheet exits the die and runs through a 3-roll calendaring stack which polishes both sides of the sheet. As the sheet travels down the line it is cooled by passing over chilled steel rolls and finally is wound up into a roll. In one embodiment the final roll comprised about 0.8 to about 1.5 mil acrylic lacquer and a 28.5 mil ABS layer for a total sheet thickness of 30 mils. Final melt temperatures of the molten resin were as follows:

| Barrel zone | Die Zone | |
|---|---|---|
| 1 - 430° F. | 1 - 480° F. | |
| 2 - 410 | 2 - 470 | |
| 3 - 420 | 3 - 430 | |
| 4 - 409 | 4 - 450 | |
| 5 - 404 | 5 - 460 | |
| Adapter | Flange | |
| A1 - 400° F. | mixer | slide |
| A2 - 400 | 480° F. | 450° F. |
| Co-extrusion block: | 400° F. | |

Die temperature is 440° F. for all zones, and melt temperature is 408° F. Line speed is 39.8 ft/min. In the 3-roll calendaring stack the start temperatures of the top, middle and bottom rolls were 170° F., 150° F. and 145° F., respectively.

### Example 3

Extrusion cap sheet lamination trials were conducted according to principles of this invention. Suitable cap sheet lamination equipment is available from Spartech, Portage, Wis. In one trial a 20 mil thick dry paint film-backing sheet laminate was cap sheet laminated to a 0.22 inch thick extrusion of 100% re-pelletized E900 TPO. Avloy® dry paint transfer films available from Avery Dennison Corporation, such as AL310036 G3, AL310043 G3 and AL310056 G3, were laminated to the 20 mil thick backing sheet of TPO material and then cap sheet laminated to the 0.22 inch extruded TPO sheet, using the heat of extrusion to laminate the backing sheet side of the preformed paint film laminate to the thick extruded substrate. In this embodiment the upper, intermediate and lower roll temperatures at the extruder die exit were 210° F., 210° F. and 150° F., respectively. In another trial a 22 mil thick dry paint laminate was laminated to a 0.230 inch TPO sheet. The upper roller at the extruder die exit in this instance was at 216° F. The process produced a 0.25 inch thick composite laminate ready for thermoforming to a finished automotive body panel.

Thus, the thin thermoformable backing sheet can be made from a high quality polymeric material free of gels or other defects, and the backing sheet will mask any gels or other defects in the extruded thick sheet to prevent them from being transmitted to the paint film side of the finished part during thermoforming. As a result, a lower grade of polymeric materials can be used for the extruded thick substrate sheet. By using a lower grade substrate material as a major portion of the final construction, the process provides significant cost savings. By thermoforming the part out of a material thick enough to be directly put onto the car, the need for injection molding the substrate component, including costly injection molding equipment and special tooling, is avoided, further reducing production costs.

### Example 4

The following formulations were used for the outer clear coat, print coats and pigmented base coat for low-gloss decorative films made according to the process of this invention. The following adhesive tie coat and size coat formulations were used in laminating the decorative print film to high molecular weight polyethylene or polypropylene extruded thick substrate sheets. The functional properties of these formulations, particularly the matte clear coat, will be described below.

Matte Clear Coat

| Component | | Parts |
|---|---|---|
| Elvacite 2042 | | 54.1 |
| Kynar 741 F | | 19.7 |
| Tinuvin 900 | | 0.61 |
| Solsperse 17000 | | 0.06 |
| TS - 100 | | 0.47 |
| Cyclohexanone | | 7.18 |
| Exxate 700 | | 7.81 |
| BLO | | 9.57 |
| G1 Print Coat | | |
| Kynar 7201 | | 58.2 |
| | {close oversize brace} | |
| El vacite 2010 | | |
| Carbon black | | 31.5 |
| Thinner | | 10.3 |
| G2 Print Coat | | |
| Kynar 7201 | | |
| | {close oversize brace} | |
| El vacite 2010 | | 58.7 |
| Buff MMO (mixed metal oxides) | | 1.40 |
| Brown MMO | | 23.8 |
| Black MMO | | 8.9 |
| Indianthrone blue | | 0.7 |
| Thinner | | 6.60 |
| G3 Print Coat | | |
| Kynar 7201 | | 47.90 |
| | {close oversize brace} | |
| El vacite 2010 | | |
| Buff MMO | | 33.90 |
| Brown MMO | | 5.70 |
| Black MMO | | 4.80 |
| Thinner | | 7.70 |
| G4 Print Coat | | |
| Kynar 7201 | | 59.10 |
| | {close oversize brace} | |
| El vacite 2010 | | |
| Buff MMO | | 1.60 |
| Brown MMO | | 10.90 |
| Black MMO | | 1.60 |
| White dispersion (T₁O₂) | | 21.50 |
| Thinner | | 5.20 |
| Color Coat | | |
| Kynar 7201 | | 58.30 |
| | {close oversize brace} | |
| El vacite 2010 | | |
| Buff MMO | | 10.40 |
| Brown MMO | | 2.0 |
| Black MMO | | 0.20 |
| White dispersion (T₁O₂) | | 21.70 |
| Thinner | | 7.30 |
| Acrylic Tie Coat | | |
| Xylene | | 59.26 |
| MEK | | 11.70 |
| Hydropel QB wax | | 0.17 |
| PEMA | | 17.17 |
| MEK | | 11.70 |
| TPO Size Coat | | |
| Toluene | | 24.93 |
| Xylene | | 41.55 |
| MEK | | 16.62 |
| EPON 828 | | 0.33 |
| Hardlen 13-LP | | 16.53 |

(1) Ratios of PVDF (Kynar) to acrylic (Elvacite) are 60:40
(2) Thinner comprises MEK and methyl propyl ketone, 1:1
(3) Hardlen 13-LP is a CPO resin used for bonding to TPO
(4) EPON 828 is an acid scavenge, blocking development of HCl in chlorinated coatings

FIGS. 9 through 12 show different embodiments of a thick sheet process for manufacturing low-gloss exterior weatherable body panels or members. The process illustrated in FIG. 9 includes a vertically disposed three roll calendaring stack comprising a lower roll 110, an intermediate roll 112 and an upper roll 114. A molten extruded sheet 115 exits an extruder die 116, passing between the lower and intermediate calendaring rolls and then around the upper roll. The starting materials for the extruded sheets shown in the processing steps of FIGS. 9 to 12 can comprise any of the resinous materials described previously, and the extruded material is pre-processed (e.g., pre-dried), also as described previously. In the illustrated embodiment, the extruded sheet is a thick substrate sheet made from a thermoformable polymeric material as described above. A preferred extruded material is high molecular weight polyolefin, 0.95 g/cc ASTM D1505.

In the embodiment of FIG. 9 a composite low-gloss laminate 117 comprising a dry paint transfer film and semi-rigid polymeric backing sheet passes directly into the calendaring roll stack. The composite laminate, also referred to as a cap sheet laminate, passes from a supply roll 118 around guide rolls 120 and 122 and then directly between the lower and intermediate calendaring rolls 110, 112 for bonding to the extruded sheet 115 as it exits the extruder die.

In one embodiment the cap sheet laminate 117 has a thickness of about 15 to 20 mils. In another embodiment, the sheet thickness of the cap sheet supporting film can be one to two mils. The thick substrate sheet 115 is extruded at a thickness that produces a total sheet thickness (cap sheet and extruded thick sheet) of about 250 to 300 mils. The thick sheet is extruded at an extrusion temperature of about 400°0 to 440° F. and the sheet temperature is reduced by passing between the lower and intermediate rolls, each operated at a temperature of about 150° to 180° F. The upper roll 114 is operated at a temperature in the range of about 180° to about 200° F. The finished sheet 123 passes downstream to a take-up roll, not shown.

The cap sheet 117 is formed as a thermoplastically formable dry paint transfer film on a heat-resistant temporary carrier. The dry paint film includes an outer clear coat comprising an alloy of PVDF and acrylic resins. In a preferred embodiment the PVDF dispersion comprises from about 50% to about 70% of the total resin solids, by weight. The carrier surface, which is not release coated, has a low gloss microroughness, and the dry paint transfer film has a protective outer clear coat layer in contact with the carrier. The outer clear coat layer comprises a polymeric binder material similar to the clear coat materials described previously. In one embodiment, the dry paint transfer film comprises the base coat/clear coat film with print patterns as described in Example 4. Generally speaking, at least one underlying base coat layer comprising a polymeric material containing a dispersed pigment is coated on the clear coat layer. The clear coat layer contains (a) uniformly dispersed filler particles in an amount below about five parts by weight of the total resin binder solids contained in the outer clear coat and (b) a dispersion of an optically transparent fluorinated polymeric material in a solvent solution of an acrylic resin. The dispersed fluorinated polymeric material has an average particle size from about 20 to about 35 microns and is uniformly dispersed in the solution of acrylic resin. A preferred solids content of the filler comprises from about 0.3 to about 1.0% by weight of the total solids contained in the clear coat formulation, with a particle size from about 20 to about 35 microns. The dry paint transfer film is transfer-laminated from the carrier to the self-supporting thermoplastically formable flexible or semi-rigid resinous backing sheet for bonding the backing sheet to a side of the dry paint transfer film opposite from the clear coat layer, thereby forming the cap sheet laminate 117.

The paint coated thick sheet laminate 123 is formed by laminating the backing sheet side of the cap sheet laminate 117 to the extruded substrate sheet 115. In one embodiment, the extruded substrate sheet 115 has a thickness at least twice the thickness of the backing sheet, and the polymeric material of the extruded substrate sheet has a substantially higher filler content than the backing sheet material, similar to the thick sheet laminates described previously. The thick sheet laminate 123 is formed to a three-dimensional shape by thermoforming techniques, as described previously, to produce a finished exterior low-gloss body panel or member. Gloss measured at 60° is below about 15 gloss units for the process of this invention, and in many cases between 6 to 12 gloss units. The dry paint transfer film on the three-dimensionally shaped part in the process of FIG. 9 comprises an exterior base coat/clear coat paint film having a uniformly distributed low-gloss surface of less than about 15 gloss units measured at 60 degrees. The low-gloss surface was transferred to the outer clear coat from the micro-roughened surface of the carrier on which the clear coat was cast. Thermoforming conditions producing sheet temperatures of about 340° to 380° F. cause the flattening aid (the dispersed particulate filler) to migrate to the surface to control gloss. The carrier was removed from the clear coat surface prior to laminating the cap sheet laminate 117 to the extruded substrate sheet 115.

FIG. 10 illustrates an alternative embodiment of a process for manufacturing low-gloss thick sheet laminates, in which a composite low-gloss laminate or cap sheet 124 is laminated to a thick extruded substrate sheet 125 downstream from the extruder die. This embodiment comprises a vertically disposed three roll calendaring stack comprising a lower roll 126, an intermediate roll 128 and an upper roll 130. The cap sheet 124 comprises a low-gloss base coat/clear coat laminate similar to that described for the FIG. 9 process, in which the outer clear coat contains the dispersion of filler material as a flattening agent and the dispersed fluoropolymer in the acrylic resin. The outer clear coat also has transferred to it the low gloss surface from the microroughened carrier on which it was cast. The thick extruded substrate sheet 125 is extruded from an extruder die 132 and passes between the lower and intermediate rolls and then around the upper laminating roll.

In the embodiment of FIG. 10 the composite low-gloss cap sheet laminate 124 passes from a supply roll 134 to a laminating roll 136 located on the extrusion line downstream from the extruder die. In this embodiment, the cap sheet is laminated to the extruded substrate sheet by passing between the lower roll 136 and the upper calendaring roll 130 for bonding the cap sheet to the extruded substrate sheet. The finished composite low-gloss laminate passes around the upper calendaring roll and then downstream to a take-up roll (not shown) . The operating conditions of the process of FIG. 10 are similar to those of FIG. 9 in that the thick substrate sheet 125 is extruded at an extrusion temperature of about 400° to 440° F. Sheet temperature is reduced by passing between the lower and intermediate rolls each operated at a temperature of about 150° to 180° F. and then to the upper roll operated at a temperature of about 180° to 200° F. In some instances, it is desirable to laminate the low-gloss cap sheet to the extruded thick substrate sheet at a reduced sheet temperature. Instead of laminating the cap sheet at the extrusion nip as in FIG. 9, the process of FIG. 10 produces a sheet temperature reduction to about 370° to 400° F. prior to laminating the cap sheet to the extruded sheet at the nip of the laminating roll 136. Laminating the cap sheet downstream from the extrusion nip makes it possible to produce proper adhesion when using certain polymeric materials having a high shrinkage problem. The reduced laminating temperature produces a more uniform bonding of the cap sheet to the extruded substrate sheet.

The thick sheet laminate 137 is then formed into a desired three-dimensional shape by thermoforming techniques as described previously to produce a finished exterior low-gloss body panel or member. As with the previous FIG. 9 process, the exterior base coat/clear coat paint film has a uniformly distributed low-gloss surface of less than about 15 gloss units measured at 60 degrees.

The dimensions of the components of the finished sheet 137 also are similar to the process of FIG. 9 in that the cap sheet laminate has a thickness of about 15 to 20 mils in one embodiment, and the substrate sheet is extruded at a thickness that produces a total sheet thickness (cap sheet and extruded thick sheet) of about 250 to 300 mils.

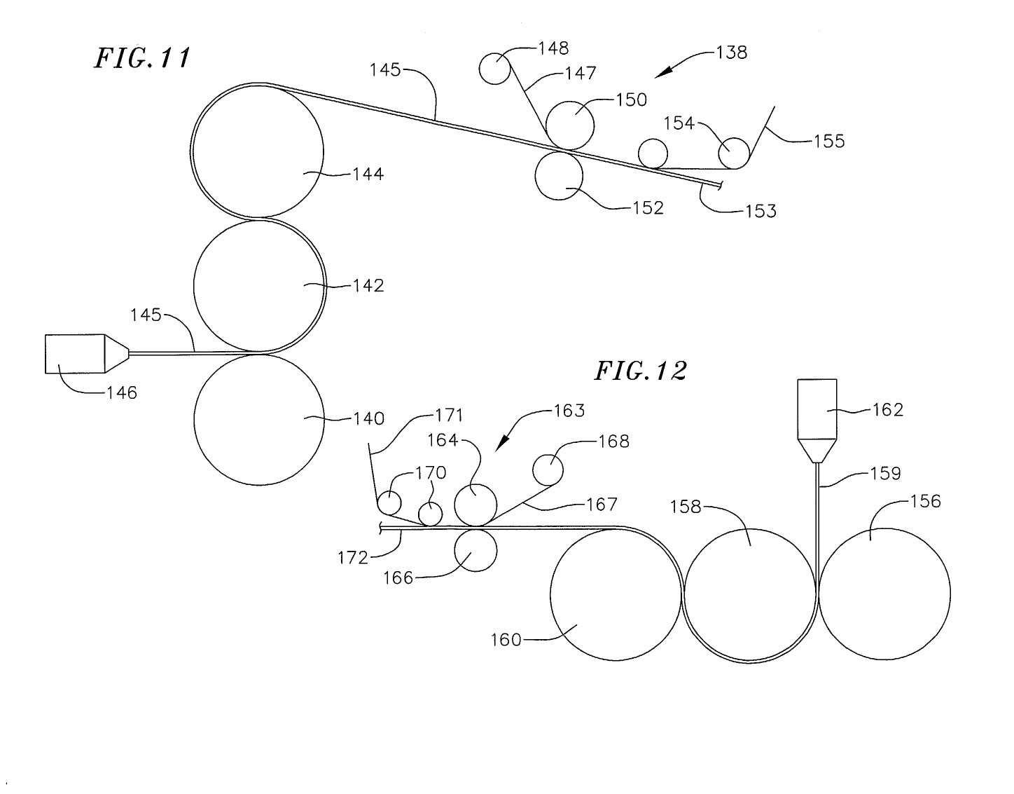

FIG. 11 illustrates a further embodiment of a process for manufacturing low-gloss thick sheet laminates, in which a low-gloss decorative film is laminated to an extruded sheet using a separate roll stand or laminating station 138 located downstream from a three roll vertical calendaring roll stack. The FIG. 11 embodiment comprises a lower calendaring roll 140, an intermediate calendaring roll 142 and an upper calendaring roll 144. A thick extruded substrate sheet 145 is extruded from an extruder die 146 and passes around the calendaring roll stack as described previously. The extruded materials for the substrate sheet are similar to those described previously. Sheet temperature of the extruded sheet can be about 400° to 440° F. as it leaves the extruder die 146. Operating temperature of the three calendaring rolls is in the range of about 150° to 180° F. for each of the three rolls.

A low-gloss decorative film 147 is laminated to the extruded sheet 145 at the roll stand 138. The decorative film 147 comprises a low-gloss base coat/clear coat film similar to that described above in which the outer clear coat contains a dispersion of filler material as a flattening agent and the dispersed fluoropolymer in the acrylic resin. In the embodiment of FIG. 11, the decorative film 147 includes a pigmented base coat comprising one or more pigmented or print coats cast on the clear coat, which in turn was cast on a microroughened polyester carrier film. At the roll stand 138, the decorative film 147 passes from a supply roll 148 through the nip of a laminating roll 150 and a backup roll 152 for bonding the base coat side of the decorative film to the extruded sheet 145. The laminating roll 150 is operated at a temperature of about 300° F. for producing good adhesion of the decorative film to the extruded sheet. The backup roll 152 is operated at ambient temperature and the sheet temperature of the finished low-gloss laminate 153 is about 180° to 200° F. The carrier sheet 155 on which the decorative film is cast is stripped from the finished sheet by stripping rolls 154, and the finished composite laminate 153 passes downstream to a take-up roll (not shown).

This embodiment provides an alternative to the cap sheet lamination embodiment of FIGS. 9 and 10 in that the decorative film on the polyester carrier is laminated directly to the thick substrate sheet, and the polyester carrier is removed on the extrusion line after bonding the decorative film using the heated laminating station. In this embodiment, the laminate 147 is size or adhesive coated for enhancing adhesion of the film to the extruded sheet. The adhesion promoting layers were gravure printed (2 gm) PEMA and reverse roll coated (12 gm) CPO (for bonding to polyolefin extruded substrate sheets). In the cap sheet processes of FIGS. 9 and 10, the decorative film side of the cap sheet laminate need not be size coated for bonding to the extruded substrate sheet.

Alternatively, the base coat/clear coat paint film can be laminated to a thin flexible supporting film, such as a 2 mil polypropylene film, and this laminate can be transfer-laminated to the extruded substrate sheet at the downstream laminating station.

The finished composite laminate 153 is then formed to a three-dimensional shape by thermoforming techniques as described previously, and the resulting three-dimensionally shaped finished part has a uniformly distributed low-gloss surface of less than about 15 gloss units measured at 60 degrees as described previously.

The process of FIG. 11 addresses the problem of undesired shrinkage of the laminate caused by the high retained temperature of the extruded substrate sheet. As the extruded sheet cools it narrows in width. In the FIG. 11 process, the decorative film is laminated to the extruded sheet downstream from the extruder die where the sheet temperature is cooled to about 180° to 190° F., i.e., where approximately 90% or more of the shrinkage has already occurred. The decorative film is laminated to the sheet at a laminating temperature in excess of the sheet temperature at that point to promote adhesion of the decorative film to the substrate sheet. The PET carrier does not shrink during the process and is removed immediately after lamination to avoid causing surface defects. This process eliminates use of a semi-rigid backing sheet in the alternative cap sheet lamination process described previously.

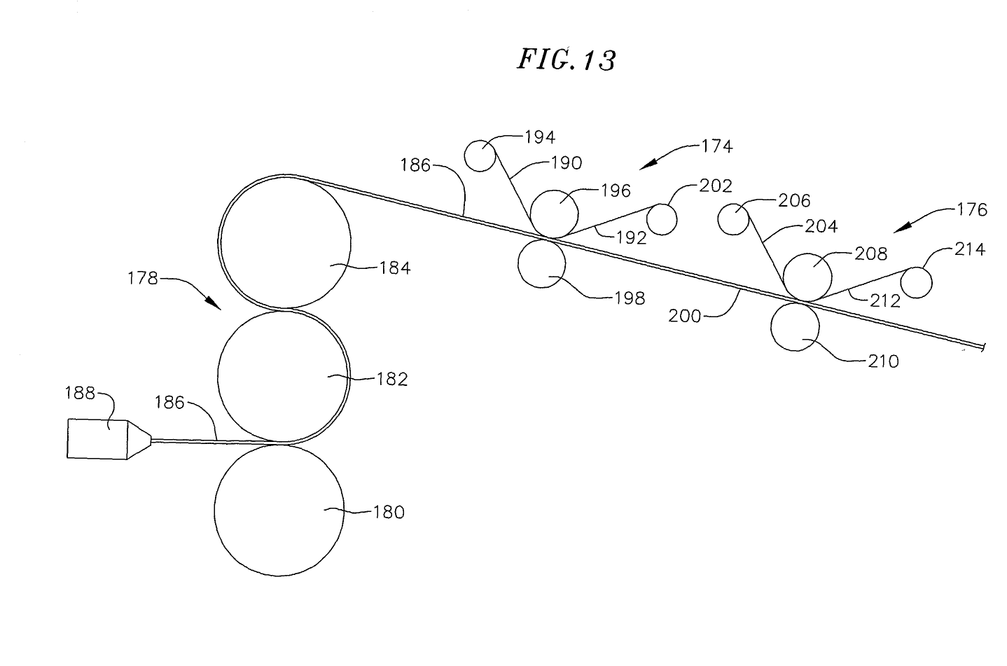

FIG. 12 illustrates an alternative process for transfer laminating a low-gloss decorative film laminate to an extruded substrate sheet downstream from a horizontal calendaring roll stack. This embodiment includes three side-by-side calendaring rolls 156, 158 and 160 disposed horizontally, in which the calendaring rolls 156 and 158 form the extrusion nip of a thick extruded substrate sheet 159 extruded from an extruder die 162. The extruded sheet passes around the intermediate extrusion calendaring roll 158 and across the calendaring roll 160 to a laminating stand 163 downstream from the calendaring roll stack. The laminating stand 163, which is similar to the laminating stand 138 described in FIG. 11, includes a heated laminating roll 164 and a backup roll 166 which form the nip for receiving a decorative film 167 passing to the laminating stand from a take-up roll 168. Stripping rolls 170 remove a microroughened low-gloss carrier sheet 171 from the finished laminate 172 downstream from the laminating stand. The low-gloss decorative sheet 167 is similar to that described in the previous embodiments and operating conditions are similar to the FIG. 11 process. The calendaring rolls are operated at 150° to 180° F., extruded sheet temperature is between about 400° to 440° F., sheet temperature at the laminating stand is from about 180° to 200° F., and the laminating roll 164 is operated at a temperature of about 300° F. As with the other embodiments of the low-gloss lamination process, the finished sheet 172 passing downstream from the laminating stand is then thermoformed into a three-dimensional shape to produce a finished part with uniform low-gloss surface. A uniform low-gloss surface of less than about 15 gloss units measured at 60 degrees was produced.

FIG. 13 illustrates a further embodiment of a process for manufacturing low-gloss thick sheet laminates in which two separate low-gloss decorative films are laminated side-by-side to an extruded sheet using two laterally offset roll stands 174 and 176 located in series downstream from a three roll vertical calendaring roll stack. The FIG. 13 embodiment comprises a lower calendaring roll 180, an intermediate calendaring roll 182, and an upper calendaring roll 184. A thick extruded substrate sheet 186 is extruded from an extruder die 188 and passes around the calendaring roll stack as described previously. The extruded materials for the substrate sheet are similar to those described previously. Sheet temperature of the extruded sheet can be about 400° to about 440° F. as it leaves the extruder die 188. Operating temperature of the three calendaring rolls is in the range of about 150° to 180° F. for each of the three rolls.

A low-gloss decorative film 190 is laminated to the extruded sheet 186 at the roll stand 174. In one embodiment, the width of the decorative film 190 is one-half the width of the extruded substrate sheet 186 and is laminated to one side of the extruded sheet. The decorative film 190 comprises a low gloss base coat/clear coat film similar to that described above, in which the outer clear coat contains a dispersion of filler material as a flattening agent and a dispersed fluoropolymer in the acrylic resin. In the embodiment of FIG. 13, the decorative film 190 includes a pigmented base coat comprising one or more pigmented or printed coats cast on the clear coat which in turn was cast on a microroughened polyester carrier film 192. At the first roll stand 174 the decorative film passes from a supply roll 194 through the nip of a laminating roll 196 and a backup roll 198 for bonding the base coat side of the decorative film to the extruded sheet 186. The laminating roll 196 is operated at a temperature of about 280° to 300° F. for producing good adhesion of the decorative film to the extruded sheet. The backup roll 198 is operated at ambient temperature and the sheet temperature of the finished low-gloss laminate 200 is about 180° to 200° F. The carrier sheet 192 on which the decorative film is cast is stripped from the finished sheet and passes to a carrier rewind roll 202.

As mentioned previously, the laminating stands 174 and 176 are located in series downstream from the calendaring roll, and the decorative film 190 applied by the first laminating stand 174 is laminated to one side of the extruded sheet 186 with the width of the sheet 190 comprising one-half of the width of the extruded sheet. The second laminating roll 176 is located further downstream beyond where the carrier film 192 is removed from the laminated decorative film 190. The second roll stand then laminates a second decorative film 204 to the other side of the extruded sheet. As an example, the first decorative sheet 190 can have a sheet thickness of about 30 inches in width and is laminated to a left side of the extruded film which has an overall width of about 60 inches. The second decorative film 204 can have a width of about 30 inches and is laminated to the right side of the extruded sheet 186. The second roll stand 176 comprises a supply roll 206 and laminating rolls 208 and 210 operated in a manner similar to laminating rolls 196 and 198. The low-gloss carrier 212 for the second decorative film 204 is taken up on a carrier rewind roll 214.

The process of FIG. 13 can be used to make decorative sheets in two-tone colors, with each decorative film 190 and 204 having a different selected color. The first film is laminated to the substrate and its carrier is removed, leaving a seam along which the second film can be freely abutted and laminated to the remaining width of the substrate, followed by removing the second carrier.

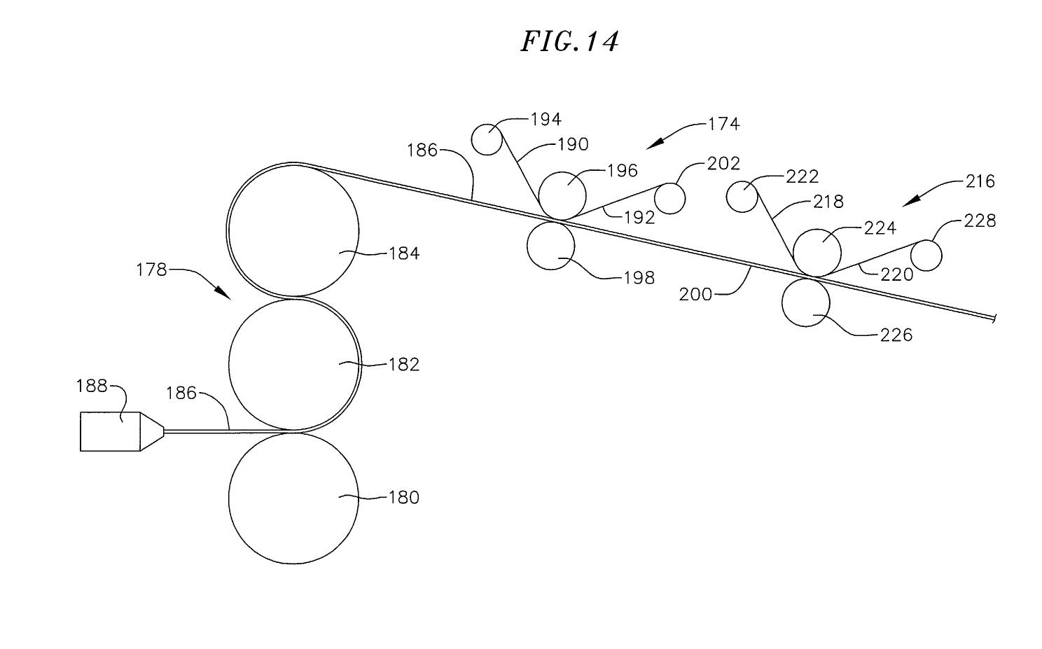

FIG. 14 illustrates a further embodiment of a process for manufacturing low-gloss thick sheet laminates having a pair of separate roll stands located downstream in series from the three roll calendaring stack. In this embodiment, the calendaring roll stack 178 and the first laminating stand 174 are identical to the arrangement shown in FIG. 13, producing a finished composite laminate 200 which passes downstream from the first roll stand toward the second roll stand 216. In this embodiment, the decorative film 190 preferably is the same width as the extruded sheet 186. At the second roll stand 216 a thermoplastic and thermoformable masking film 218 is applied to the surface of the previously laminated decorative film 190. The masking film comprises a protective outer film which is bonded to the decorative film and remains in place on the decorative film as a protective outer liner. These masking films are known in the art and are capable of elongating with the decorative sheet under thermoforming conditions to maintain the gloss and DOI levels of the outer film surface during the thermoforming process. The masking film can be stripped from the finished product at a later point in the process typically after the finished product is completed. In the FIG. 14 embodiment, the masking film passes from a supply roll 222 through the nip of a laminating roll 224 and a backup roll 226. The carrier 220 on which the masking film is supported is removed and taken up on a rewind roll 228. The process of FIG. 13 speeds the process of applying such masking films by applying the decorative film, removing its carrier, and then applying the masking film in-line.

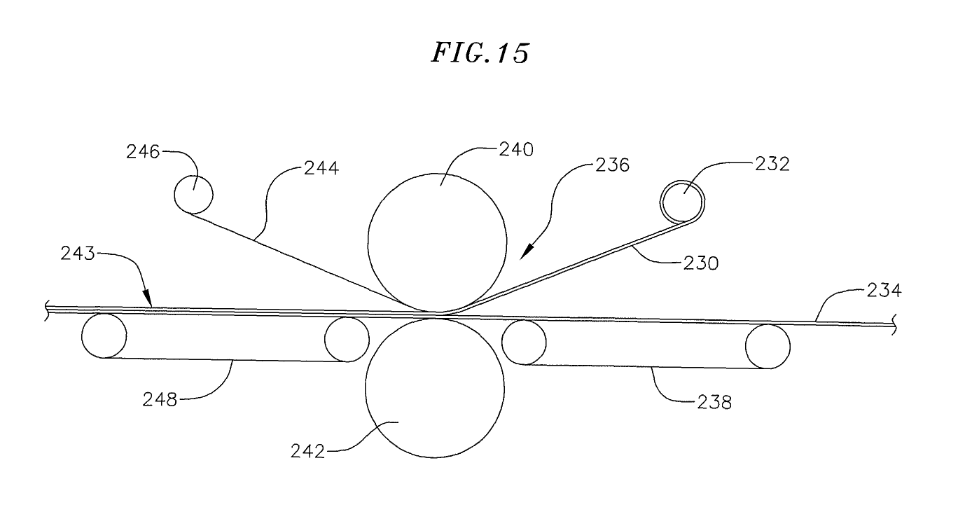

FIG. 15 shows a flat sheet laminator process for laminating a decorative sheet material to a thick substrate sheet. In this lamination process, a decorative film 230 is unwound from a supply roll 232 and laminated to a thick flat substrate sheet 234, fed to the nip of the laminator 236 by a horizontally disposed endless feed belt 238. The flat substrate sheet has been extruded and cooled to a temperature which does not create a shrinkage problem with lamination to the decorative film. The decorative film comprises a low gloss base coat/clear coat film similar to that described previously. The decorative film is supported by a polyester carrier sheet and this combination is fed to the nip of the laminator which comprises a heated polished laminating roll 240 and a backup roll 242. The laminating temperature of the heated roll is about 400° F., sufficient for laminating the decorative film to the moving substrate sheet. The laminator bonds the decorative film to the flat substrate sheet to produce a finished laminate 243. The thick substrate sheet can be in the range of about 60 to 80 mils up to about 300 mils and can comprise ABS, TPO, or other substrate materials as described previously. The carrier sheet 244 is stripped from the finished sheet and taken up on a carrier rewind roll 246. An endless takeoff belt 248 on the downstream side of the laminator transports the finished laminate 243 away from the laminator.

### Example 5

A low-gloss printed base coat/clear coat paint film was laminated to a 15 mil thick semi-rigid polymeric backing sheet comprising a high molecular weight polyethylene (Marlex polyethylene). The clear coat and color coat layers of the low-gloss film were made from the formulations described in Example 4. The cap sheet was laminated to a two-layer coextruded thick substrate sheet made from the same high molecular weight polyethylene. One layer was buff in color acting as a background color to the printed pattern of the decorative film, and the other side of the coextrusion was tan in color for color matching. The ratios were 75% to 25%, respectively. The finished laminated sheet had a total thickness of 250 mils (0.25 inch). The cap sheet lamination step was similar to the process of FIG. 10. Gloss of less than 10 gloss units was measured on a 60 degree gloss meter. The low-gloss was uniformly distributed across the surface of the finished part.

### Example 6

A low-gloss printed base coat/clear coat film similar to the film used in Example 5 was laminated to a flexible 2 mil thick polypropylene (Extrell polypropylene) supporting film. The resulting laminate was then cap sheet laminated to the same two layer coextrusion described in Example 5. The resulting laminate had a total thickness of 250 mils. The cap sheet lamination step was similar to the FIG. 10 process and a low-gloss similar to that produced by the part in FIG. 5 was distributed uniformly across the surface of the finished part.

### Example 7

A low-gloss base coat/clear coat decorative film having a camouflage print pattern was size coated with the adhesive layers of Example 4 and then laminated directly to a 250 mil two-layer coextruded high molecular weight polyethylene sheet similar to the extruded sheet described in Examples 5 and 6. The decorative film was laminated in the extrusion line downstream from the extruder die at a heated laminating station similar to the process of FIG. 11. The low-gloss microroughened polyester carrier was removed from the outer clear coat in line. A gloss of less than 10 gloss units was measured on a 60 degree gloss meter, and this low-gloss surface was uniformly distributed across the surface of the finished part.

Uniform low-gloss levels in thermoformed parts can be difficult to achieve because of the elongation of the paint film. Gloss level is controlled in part by casting the outer clear coating on a matte (low-gloss polyester) carrier which, when heated, normally tends to smooth out (gloss-up). The inert filler acts as a flattening aid so that the material, if stretched during forming, remains low-gloss. Low level gloss also is achieved by selection of particle size of the flattening aid and its proportionate amount in the clear coat formulation. The particulate filler additive tends to migrate to the surface of the clear coat during thermoforming which tends to maintain a low-gloss matte surface on the clear coat layer in contact with the carrier. Uneven thinning of a three-dimensional part also can cause uneven gloss and color changes at different elongations. A solution to the problem of maintaining uniform low-gloss levels also includes using a homopolymer PVDF dispersion coating as opposed to a solution coating, to help act as a flattening aid along with casting onto a matte polyester carrier. This in combination with using the inert filler to act as a flattening aid during thermoforming produces a uniform loss-gloss gloss surface on the finished three-dimensionally shaped part. Also, the forming process controls stretching of the decorative film so that there is a minimum of about 10% to about 20% elongation. This causes the flattening aid to roughen up the surface evenly. (Percent elongation is measured by 100 times the difference in sheet thickness before and after thermoforming divided by sheet thickness after thermoforming.) Because the outer layer is a clear coat, the filler is transparent in the coating and has a small enough particle size not to be visibly seen in the finished coating.

1. A process for making a low-gloss exterior body panel or member, comprising the steps of:
forming a thermoplastically formable dry paint transfer film on a heat-resistant temporary carrier, the carrier surface having a low-gloss microroughness, the dry paint transfer film having a protective outer clear coat layer in contact with the carrier and comprising a polymeric material, and at least one underlying base coat layer comprising a polymeric material containing a dispersed pigment, the clear coat layer containing (a) uniformly dispersed filler particles in an amount below about five parts by weight of the total resin binder solids contained in the outer clear coat and (b) a dispersion of an optically transparent fluorinated polymeric material in a solvent solution of an acrylic resin, the dispersed fluorinated polymeric material having an average particle size from about 20 to about 35 microns and being uniformly dispersed in the solution of acrylic resin;
transferring the dry paint transfer film from the carrier to a thermoplastically formable resinous backing sheet or film adhered to a side of the dry paint transfer film opposite from the clear coat layer, to thereby form a cap sheet laminate;
extruding a relatively thick substrate sheet comprising a thermoformable polymeric material;
forming a paint-coated thick sheet laminate by laminating the backing sheet or film side of the cap sheet laminate to the extruded substrate sheet, the extruded substrate sheet having a thickness at least twice the thickness of the backing sheet or film, and in which the polymeric material of the extruded substrate sheet has a substantially higher filler content than the backing sheet or film material; and
forming the thick sheet laminate to a three-dimensional shape to produce a finished exterior low-gloss body panel or member on which the dry paint transfer film comprises an exterior base coat/clear coat paint film having a uniformly distributed low-gloss surface of less than about 15 gloss units measured at 60 degrees, said low-gloss surface transferred from the microroughened surface of the carrier.

2. The process according to claim 1 in which the polymeric material of the backing sheet has a lower gel count than the extruded substrate sheet material.

3. The process according to claim 1 in which the extruded substrate sheet has a thickness at least three times the thickness of the backing sheet.

4. The process according to claim 1 including coextruding the backing sheet and a bonding layer on the backing sheet for bonding to the dry paint transfer film.

5. The process according to claim 4 in which the coextrusion step is followed by laminating the dry paint film to the bonding layer on the coextrusion.

6. The process according to claim 1 in which the fluorinated polymeric material comprises PVDF.

7. The process according to claim 1 in which the dry paint transfer film is subjected to elongation of at least about 20% during thermoforming.

8. The process according to claim 1 in which the fine particulate filler comprises finely divided silica particles.

9. The process according to claim 1 in which the backing sheet or film comprises a semi-rigid resinous sheet selected from the group consisting of polyolefin, including high molecular weight polyethylene and polypropylene, ABS, polycarbonate, and blends thereof.

10. The process according to claim 1 in which the cap sheet laminate is laminated to the extruded sheet downstream from the extruder die after subjecting the cap sheet laminate to a sheet temperature reduction of at least about 7%.

11. The process according to claim 1 in which the particle size of the filler is from about 20 to about 35 microns.

12. A process for making a low-gloss exterior body panel or member, comprising the steps of:
forming a thermoplastically formable dry paint transfer film on a heat-resistant temporary carrier, the carrier surface having a low-gloss microroughness, the paint transfer film having a protective outer clear coat layer comprising a polymeric material, and at least one underlying base coat layer comprising a polymeric material containing a dispersed pigment, the clear coat layer containing (a) uniformly dispersed filler particles in an amount below about five parts by weight of the total resinous binder solids contained in the outer clear coat and (b) a dispersion of an optically transparent fluorinated polymeric material in a solvent solution of an acrylic resin, the dispersed fluorinated polymeric material having an average particle size from about 20 to about 35 microns and being uniformly dispersed in the solution of acrylic resin;
forming a pre-formed dry paint laminate by laminating the dry paint transfer film to a thermoplastically formable resinous backing sheet of film adhered to a side of the dry paint transfer film opposite from the clear coat layer;
extruding a relatively thick substrate sheet comprising a thermoformable polymeric material;
forming a paint-coated thick sheet laminate by laminating the backing sheet or film side of the pre-formed dry paint laminate to the extruded substrate sheet;
the clear coat layer having been dried in contact with the carrier and transferred therefrom to transfer the surface microroughness of the carrier to an outer surface of the clear coat layer to reduce the surface gloss of the clear coat layer; and
forming the thick sheet laminate to a three-dimensional shape to produce a finished exterior body panel or member on which the dry paint transfer film comprises an exterior base coat/clear coat paint film having a uniformly distributed low-gloss surface of less than about 15 gloss units measured at 60 degrees.

13. The process according to claim 12 in which the backing sheet or film side of the pre-formed laminate is bonded to the extruded substrate sheet downstream from an extruder die that extrudes the substrate sheet, for bonding to the extruded sheet at a sheet temperature substantially less than the heat of extrusion at the extruder die, and removing the carrier from the dry paint transfer film at the downstream location where the pre-formed laminate is bonded to the extruded sheet.

14. The process according to claim 12 in which the polymeric material of the backing sheet has a lower gel count than the thicker extruded substrate sheet material, and the extruded substrate sheet has a thickness at least three times the thickness of the backing sheet or film.

15. The process according to claim 12 in which the fluorinated polymeric material comprises PVDF.

16. The process according to claim 12 in which the dry paint transfer film is subjected to elongation of at least about 10% during thermoforming.

17. The process according to claim 12 in which the fine particulate filler has a particle size from about 20 to about 35 microns.

18. The process according to claim 12 in which the backing sheet or film comprises a semi-rigid resinous sheet selected from the group consisting of polyolefin, including high molecular weight polyethylene and polypropylene, ABS, polycarbonate, and blends thereof.

19. The process according to claim 12 in which the cap sheet laminate is laminated to the extruded sheet downstream from the extruder die after subjecting the cap sheet laminate to a sheet temperature reduction of at least about 7%.

20. The process according to claim 12 in which the particle size of the filler is from about 20 to about 35 microns.

21. A process for making a low-gloss exterior body panel or member, comprising the steps of:
forming a thermoplastically formable dry paint transfer film on a heat-resistant temporary carrier, the carrier surface having a low-gloss microroughness, the dry paint transfer film having a protective outer clear coat layer in contact with the carrier and comprising a polymeric material, and at least one underlying base coat layer comprising a polymeric material containing a dispersed pigment, the clear coat layer containing (a) uniformly dispersed filler particles in an amount below about five parts by weight of the total resin binder solids contained in the outer clear coat and (b) a dispersion of an optically transparent fluorinated polymeric material in a solvent solution of an acrylic resin, the dispersed fluorinated polymeric material having an average particle size from about 20 to about 35 microns and being uniformly dispersed in the solution of acrylic resin;
extruding a relatively thick substrate sheet comprising a thermoformable polymeric material through an extruder die; and
forming a paint-coated thick sheet laminate by laminating the pre-formed dry paint laminate to the extruded sheet following a temperature reduction applied to the extruded sheet by contact with a cooling surface;
the clear coat layer having been dried in contact with the carrier and transferred therefrom to transfer its surface microroughness to the outer surface of the clear coat;
the thick sheet laminate formable to a three-dimensional shape to produce a finished exterior low-gloss body panel or member in which the dry paint transfer film comprises an exterior base coat/clear coat paint film having a uniformly distributed low-gloss surface of less than about 15 gloss units measured at 60 degrees.

22. The process according to claim 21 in which the fluorinated polymeric material comprises PVDF.

23. The process according to claim 21 in which the dry paint transfer film is subjected to elongation of at least about 10% during thermoforming.

24. The process according to claim 21 in which the fine particulate filler has a particle size from about 20 to about 35 microns.

25. The process according to claim 21 in which the backing sheet or film side of the pre-formed laminate is bonded to the extruded substrate sheet downstream from an extruder die that extrudes the substrate sheet, for bonding to the extruded sheet at a sheet temperature substantially less than the heat of extrusion at the extruder die, and removing the carrier from the dry paint transfer film at the downstream location where the pre-formed laminate is bonded to the extruded sheet.

26. The process according to claim 21 in which the cap sheet laminate is laminated to the extruded sheet downstream from the extruder die after subjecting the cap sheet laminate to a sheet temperature reduction of at least about 7%.

27. The process according to claim 21 in which the cooling surface comprises at least one calendering roll operated at a temperature below the sheet temperature at the extruder die, followed by laminating the dry paint laminate to the extruded substrate sheet downstream from the calendering roll at a laminating temperature at least about 20% below said sheet temperature.

28. The process according to claim 21 in which the dry paint laminate is laminated to the extruded substrate sheet following a temperature reduction sufficient to produce at least about 90% of the total shrinkage to occur in the extruded sheet.

29. A low-gloss exterior body panel or member, comprising:
a thermoplastically formable dry paint transfer film having a protective outer clear coat layer comprising a polymeric material and at least one underlying base coat layer comprising a polymeric material containing a dispersed pigment, the clear coat layer containing (a) uniformly dispersed filler particles in an amount below about five parts by weight of the total resinous binder solids contained in the outer clear coat and (b) a dispersion of a fluorinated polymeric material in a solvent solution of an acrylic resin, the dispersed fluorinated polymeric material having an average particle size from about 20 to about 35 microns and being uniformly dispersed in the solution of acrylic resin, the clear coat layer having been dried in contact with a heat-resistant temporary carrier surface having a low-gloss microroughness to transfer the surface microroughness from the carrier to the outer surface of the clear coat layer;
a thermoplastically formable resinous backing sheet or film adhered to the side of the paint transfer film opposite from the clear coat layer;
a relatively thick extruded substrate sheet comprising a thermoformable polymeric material bonded to the backing sheet or film and thereby forming a thick sheet laminate, the extruded substrate sheet having a thickness at least twice the thickness of the backing sheet or film, the polymeric material of the extruded substrate sheet having a substantially higher filler content than the backing sheet material;
the resulting thick sheet laminate having been thermoformed to a three-dimensional shape to produce a finished exterior body panel or member in which the dry paint transfer film comprises an exterior base coat/clear coat paint film having a low-gloss uniformly distributed surface gloss of less than about 15 gloss units measured at 60 degrees.

30. The product according to claim 29 in which the particle size of the filler is from about 20 to about 35 microns.
